(19) United States
(12) Patent Application Publication
(10) Pub. No.: US 2012/0284289 A1
(43) Pub. Date: Nov. 8, 2012

(54) METHOD AND APPARATUS FOR PREVIEWING APPLICATION SUBJECT CONTENT

(76) Inventors: Yu ZHANG, Beijing (CN); Zhao Liu, Beijing (CN)

(21) Appl. No.: 13/552,057

(22) Filed: Jul. 18, 2012

Related U.S. Application Data
(63) Continuation of application No. PCT/CN2011/071848, filed on Mar. 16, 2011.

(30) Foreign Application Priority Data
Mar. 17, 2010 (CN) 201010127172.7

(51) Int. Cl. G06F 17/30

(52) U.S. Cl. 707/755; 707/705; 707/E17.009

(57) ABSTRACT

A method for previewing application subject content includes: obtaining a highlight application request selected on a user interface and retention time of the highlight application request; obtaining corresponding file content according to the highlight application request if the retention time is greater than or equal to a preset time threshold; and previewing the file content. In the method and the apparatus for previewing application subject content provided by the embodiments of the present invention, the highlight application request selected on the user interface is obtained, and the corresponding file content is obtained according to the highlight application request when the retention time is greater than or equal to the preset threshold, so that the interface style of the selected highlight application and the file content of a Java application may be obtained without accessing the Java application, and thereby user experience is improved.

### CROSS-REFERENCE TO RELATED APPLICATIONS

This application is a continuation of International Application No. PCT/CN2011/071848, filed on Mar. 16, 2011, which claims priority to Chinese Patent Application No. 201010127172.7, filed on Mar. 17, 2010, both of which are hereby incorporated by reference in their entireties.

### FIELD OF THE INVENTION

The present invention relates to the field of communications, and in particular, to a method and an apparatus for previewing application subject content.

### BACKGROUND OF THE INVENTION

Currently, in a Java applied management system (Applied Management System, AMS for short), a Java application generally reads a default icon from a Java Archive (Java Archive, jar for short) file and displays the icon on a user interface of a mobile terminal in form of a list. Because the interface is composed of static graphics, it is stiff for terminal users and does not attract the visual perception of the users. Furthermore, a single resource file cannot achieve the effect of a diversified interface, cannot bring strong visual impact to the terminal users, and cannot attract avant-garde persons.

### SUMMARY OF THE INVENTION

Embodiments of the present invention provide a method and an apparatus for previewing application subject content, so as to obtain file content of a Java AMS without accessing the Java AMS, thereby improving the user experience.

An embodiment of the present invention provides a method for previewing application subject content, where the method includes:
obtaining a highlight application request selected on a user interface and retention time of the highlight application request;
obtaining corresponding file content according to the highlight application request if the retention time is greater than or equal to a preset threshold; and
previewing the file content.

An embodiment of the present invention provides an apparatus for previewing application subject content, where the apparatus includes:
a first obtaining module, configured to obtain a highlight application request selected on a user interface and retention time of the highlight application request;
a second obtaining module, configured to obtain corresponding file content according to the highlight application request if the retention time is greater than or equal to a preset threshold; and
a previewing module, configured to preview the file content.

In the method and the apparatus for previewing application subject content provided by the embodiments of the present invention, the highlight application request selected on the user interface is obtained, and the corresponding file content is obtained according to the highlight application request when the retention time is greater than or equal to the preset threshold, so that the interface style of the selected highlight application and the file content of a Java application can be obtained without accessing the Java application, thereby user experience is improved.

### BRIEF DESCRIPTION OF THE DRAWINGS

The accompanying drawings described herein are provided for further understanding of the present invention, which are a part of the application, but are not intended to limit the present invention. In the accompanying drawings:

FIG. 1 is a flowchart of an embodiment of a method for previewing application subject content according to the present invention;

FIG. 2 is a flowchart of another embodiment of the method for previewing application subject content according to the present invention;

FIG. 3 is a schematic structural diagram of an embodiment of an apparatus for previewing application subject content according to the present invention; and

FIG. 4 is a schematic structural diagram of another embodiment of the apparatus for previewing application subject content according to the present invention.

### DETAILED DESCRIPTION OF THE EMBODIMENTS

To make the objectives, technical solutions, and advantages of the present invention clearer, the present invention is further described in detail below through embodiments with reference to the accompanying drawings. Herein, the exemplary embodiments of the present invention and descriptions of the embodiments are intended to only explain the present invention, instead of limiting the present invention.

According to the Mobile Information Device Profile (Mobile Information Device Profile, MIDP for short), generally there is a Java application descriptor (Java application Descriptor, JAD for short) file for a Java application, and the JAD file is used for describing attributes of the Java application, such as the information of a provider, version and size.

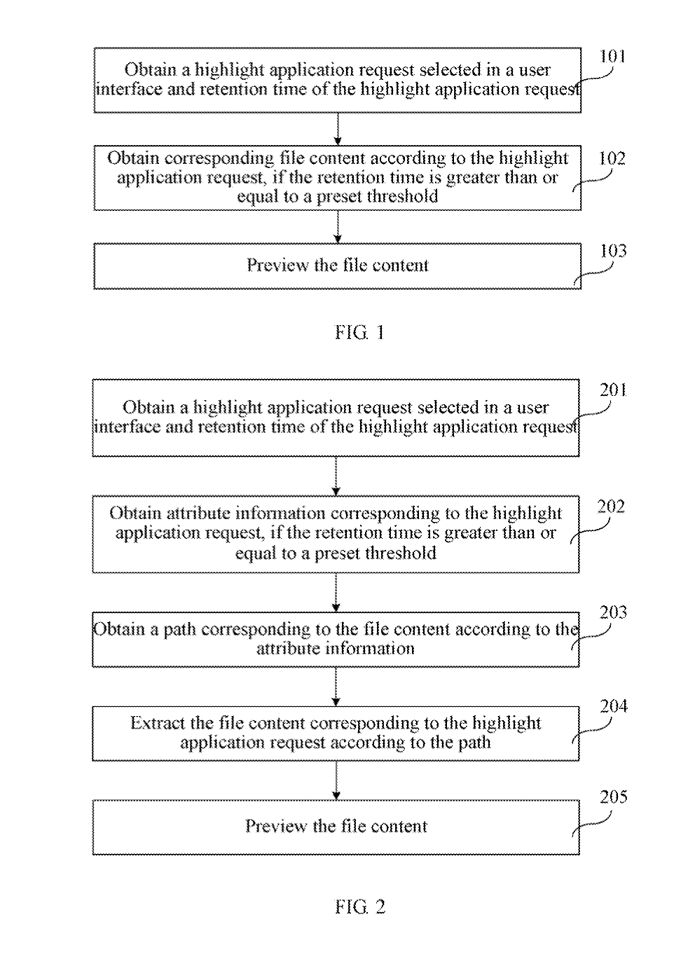

FIG. 1 is a flowchart of an embodiment of a method for previewing application subject content according to the present invention. As shown in FIG. 1, the embodiment includes the following steps:

Step 101: Obtain a highlight application request selected on a user interface and retention time of the highlight application request.

Step 102: Obtain corresponding file content according to the highlight application request if the retention time is greater than or equal to a preset threshold.

Step 103: Preview the file content.

In the method for previewing application subject content provided by the embodiment of the present invention, the highlight application request selected on the user interface is obtained, and the corresponding file content is obtained according to the highlight application request when the retention time is greater than or equal to the preset threshold, so that the interface style of the selected highlight application and the file content of a Java application can be obtained without accessing the Java application, and thus user experience is improved.

FIG. 2 is a flowchart of another embodiment of the method for previewing application subject content according to the present invention. As shown in FIG. 2, this embodiment includes the following steps:

Step 201: Obtain a highlight application request selected on a user interface and retention time of the highlight application request.

Because Java applications are listed on a Java AMS interface as icons, when a user moves a focus, a selected Java application triggers and generates the highlight application request. The terminal further triggers and generates a corresponding highlight application request by obtaining the Java application selected by the user, so as to achieve highlight effect and enable terminal users to clearly know the Java application that obtains the focus. Wherein the Java application may be, for example, a game item. The retention time of the highlight application request in this embodiment refers to the time length that the focus is obtained by the currently selected Java application continuously.

Step 202: Obtain corresponding attribute information of the highlight application request if the retention time is greater than or equal to a preset threshold.

In the MIDP specification, the JAD file is a descriptor file for a java application and stores each attribute of the java application; each attribute of the java application includes a field attribute and corresponding content, for example, an attribute of the java application is the size of the file, and the size attribute of the file includes a “MIDlet-Jar-Size” field attribute and the corresponding file size value of the “MIDlet-Jar-Size” field attribute. A path of the file content corresponding to the highlight application request may be further obtained by obtaining an attribute of each field and the content corresponding to each field.

Specifically, in the embodiment of the present invention, an extended attribute of a preview attribute (MIDlet-preview) is added in the JAD file of the Java application, wherein the extended attribute indicates the file content that needs to be displayed by the current application corresponding to the highlight application request. The file content may specifically be a graphics file, a video file or an audio file.

Step 203: Obtain the path corresponding to the file content according to the attribute information.

Because executable code segments of the Java application and resources that may be used by the Java application are packed as a part of the JAD file and stored in a mobile phone, the preview attribute (MIDlet-preview) needs to be used to obtain a path accurately pointing to the file content. Specifically, the Java AMS obtains the field attribute named preview attribute (MIDlet-preview) by parsing each field attribute in the JAD file. The value of the field attribute is the path corresponding to the file content, for example, a field attribute is: resource file path+file name+extension of the file name (MIDlet-preview: path+filename+extendname).

Step 204: Extract the file content corresponding to the highlight application request according to the path.

Search and check whether the JAD file contains the preview attribute (MIDlet-preview), and if the JAD file contains the preview attribute, a corresponding media file exists in the subdirectory of the JAD file, and therefore the file content corresponding to the highlight application is obtained.

Step 205: Preview the file content.

Reasonable layout can be made, for example, if the file content is a dynamic graphics of “gif” or a static graphics such as “png”, the file content is decoded and displayed in full screen; if the file content is a video file, the video file is played and displayed on a display interface in full screen; while if the file content is an audio file, the original style of the display interface is maintained and the audio file is played by using a loudspeaker.

In the method for previewing application subject content provided by the embodiment of the present invention, the highlight application request selected on the user interface is obtained, and the corresponding file content is obtained according to the highlight application request when the retention time is greater than or equal to the preset threshold, so that the interface style of the selected highlight application and the file content of the Java application can be obtained without accessing the Java application, thereby improving user experience.

In addition, based on the embodiments shown in FIG. 1 and FIG. 2, if the obtained retention time is smaller than the preset threshold, it indicates that the user just accesses the Java AMS, and a Java application list is still displayed according to the display mode in the prior art; while if the obtained retention time is greater than or equal to the preset threshold, the Java application corresponding to the highlight application request is obtained, and the file (preview) content corresponding to the Java application is displayed on the display interface. When a new highlight application request that the user is switched to is obtained, the display content is correspondingly changed according to the new highlight application request. If the file content (for example, the MIDlet-preview) corresponding to the highlight application request does not exist, the file content of the Java AMS is displayed according to the display mode in the prior art.

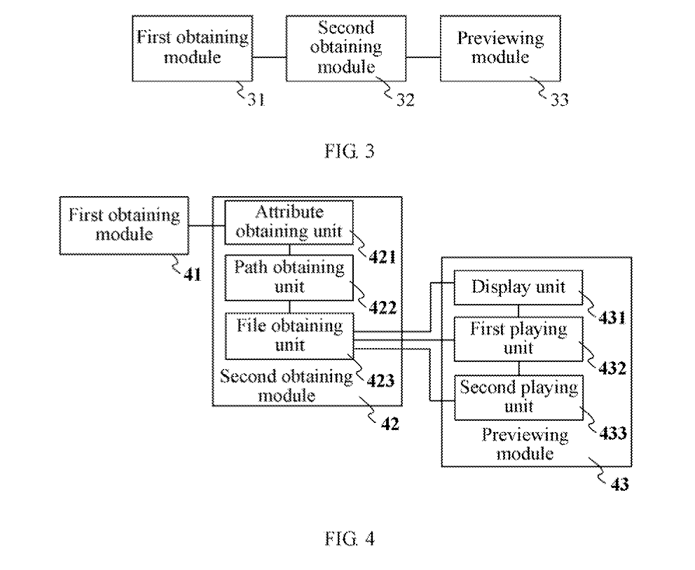

FIG. 3 is a schematic structural diagram of an embodiment of an apparatus for previewing application subject content according to the present invention. As shown in FIG. 3, this embodiment includes: a first obtaining module 31, a second obtaining module 32, and a previewing module 33.

The first obtaining module 31 obtains a highlight application request selected on a user interface and retention time of the highlight application request. If the retention time is greater than or equal to a preset threshold, the second obtaining module 32 obtains corresponding file content according to the highlight application request. The previewing module 33 previews the file content obtained by the second obtaining module 32.

The highlight application request in the embodiment of the present invention may specifically be triggered and generated by a Java application.

In the apparatus for previewing application subject content provided by the embodiment of the present invention, the first obtaining module 31 obtains the highlight application request selected on the user interface, and when the retention time is greater than or equal to the preset threshold, the second obtaining module 32 obtains the corresponding file content according to the highlight application request, so that the interface style of the selected highlight application and the file content of the Java application can be obtained without accessing the Java application, thereby user experience is improved.

FIG. 4 is a schematic structural diagram of another embodiment of the apparatus for previewing application subject content according to the present invention. As shown in FIG. 4, this embodiment includes: a first obtaining module 41, a second obtaining module 42, and a previewing module 43.

The first obtaining module 41 obtains a highlight application request selected on a user interface and retention time of the highlight application request. If the retention time is greater than or equal to a preset threshold, the second obtaining module 42 obtains corresponding file content according to the highlight application request. The previewing module 43 previews the file content obtained by the second obtaining module 42.

Further, the second obtaining module 42 may also include: an attribute obtaining unit 421, a path obtaining unit 422, and a file obtaining unit 423. The attribute obtaining unit 421 obtains attribute information corresponding to the highlight application request. The path obtaining unit 422 obtains a path corresponding to the file content according to the attribute information. The file obtaining unit 423 extracts the file content corresponding to the highlight application request according to the path.

Further, the path obtaining unit 422 may also include: a parsing subunit and an obtaining subunit. The parsing subunit is configured to parse a field attribute in an application descriptor file. The obtaining subunit is configured to obtain a field attribute of a preview attribute from the parsed field attribute field in the application descriptor file, wherein a value of the field attribute is the path corresponding to the file content.

Further, the previewing module 43 may also include: a display unit 431, a first playing unit 432, and a second playing unit 433. If the file content is a graphics file, the display unit 431 displays the graphics file on a display interface in a dynamic mode. If the file content is a video file, the first playing unit 432 plays the video file on the display interface. If the file content is an audio file, the second playing unit 433 plays the audio file by using a loudspeaker.

The highlight application request in the embodiment of the present invention can specifically be triggered and generated by a Java application.

In the apparatus for previewing application subject content provided by the embodiment of the present invention, the first obtaining module 41 obtains the highlight application request selected on the user interface, and when the retention time is greater than or equal to the preset threshold, the second obtaining module 42 obtains the corresponding file content according to the highlight application request, so that the interface style of the selected highlight application and the file content of the Java application can be obtained without accessing the Java application, thereby user experience is improved.

Persons skilled in the art should understand that all or a part of the steps in the method of the embodiments may be accomplished through a program instructing related hardware. The program may be stored in a computer readable storage medium, including a ROM, a RAM, a magnetic disk, a CD disk, or the like.

The objectives, technical solutions, and beneficial effects of the present invention have been described in further detail through the above specific embodiments. It should be understood that the above descriptions are merely specific embodiments of the present invention, but not intended to limit the protection scope of the present invention. Any modification, equivalent replacement, or improvement made without departing from the spirit and principle of the present invention shall fall within the protection scope of the present invention.

What claimed is:

1. A method for displaying application subject content, comprising:
obtaining, by a terminal, a highlight application request selected on a user interface and retention time of the highlight application request;
obtaining, by the terminal, corresponding file content according to the highlight application request if the retention time is greater than or equal to a preset threshold; and
displaying, by the terminal, the file content.

2. The method according to claim 1, wherein the highlight application request is triggered and generated by a Java application.

3. The method according to claim 2, wherein the obtaining, by the terminal, the corresponding file content according to the highlight application request comprises:
obtaining, by the terminal, attribute information corresponding to the highlight application request;
obtaining, by the terminal, a path corresponding to the file content according to the attribute information; and
extracting, by the terminal, the file content corresponding to the highlight application request according to the path.

4. The method according to claim 3, wherein the obtaining, by the terminal, the path corresponding to the file content according to the attribute information comprises:
parsing, by the terminal, a field attribute in an application descriptor file; and
obtaining, by the terminal, a field attribute of a preview attribute from the parsed field attribute in the application descriptor file, wherein a value of the field attribute of the preview attribute is the path corresponding to the file content.

5. The method according to claim 1, wherein the displaying, by the terminal, the file content comprises at least one of following:
if the file content is a graphics file, displaying, by the terminal, the graphics file on a display interface in a dynamic mode;
if the file content includes a video file, playing, by the terminal, the video file on the display interface; and
if the file content includes an audio file, playing, by the terminal, the audio file by using a loudspeaker.

6. An terminal for displaying application subject content, comprising:
a first obtaining module, configured to obtain a highlight application request selected on a user interface and retention time of the highlight application request;
a second obtaining module, configured to obtain corresponding file content according to the highlight application request if the retention time is greater than or equal to a preset threshold; and
a previewing module, configured to preview the file content.

7. The terminal according to claim 6, wherein the highlight application request is triggered and generated by a Java application.

8. The terminal according to claim 7, wherein the second obtaining module comprises:
an attribute obtaining unit, configured to obtain attribute information corresponding to the highlight application request;
a path obtaining unit, configured to obtain a path corresponding to the file content according to the attribute information; and
a file obtaining unit, configured to extract the file content corresponding to the highlight application request according to the path.

9. The terminal according to claim 8, wherein the path obtaining unit comprises:
a parsing subunit, configured to parse a field attribute in an application descriptor file; and
an obtaining subunit, configured to obtain a field attribute of a preview attribute from the parsed field attribute in the application descriptor file, wherein a value of the field attribute is the path corresponding to the file content.

10. The terminal according to claim 6, wherein the previewing module comprises at least one of following:
a display unit, configured to display the graphics file on a display interface in a dynamic mode if the file content includes a graphics file;
a first playing unit, configured to play the video file on the display interface if the file content includes a video file; and
a second playing unit, configured to play the audio file by using a loudspeaker if the file content includes an audio file.

11. An apparatus for previewing application subject content, comprising at least one processor and a memory coupled to the at least one processor; wherein the at least one processor are configured to:
obtain a highlight application request selected on a user interface and retention time of the highlight application request;
obtain corresponding file content according to the highlight application request if the retention time is greater than or equal to a preset threshold; and
preview the file content.

12. The apparatus according to claim 11, wherein the highlight application request is triggered and generated by a Java application.

13. The apparatus according to claim 12, wherein the obtaining the corresponding file content according to the highlight application request comprises:
obtaining attribute information corresponding to the highlight application request;
obtaining a path corresponding to the file content according to the attribute information; and
extracting the file content corresponding to the highlight application request according to the path.

14. The apparatus according to claim 13, wherein the obtaining the path corresponding to the file content according to the attribute information comprises:
parsing a field attribute in an application descriptor file; and
obtaining a field attribute of a preview attribute from the parsed field attribute in the application descriptor file, wherein a value of the field attribute of the preview attribute is the path corresponding to the file content.

15. The apparatus according to claim 11, wherein the previewing the file content comprises at least one of following:
displaying the graphics file on a display interface in a dynamic mode if the file content includes a graphics file;
playing the video file on the display interface if the file content includes a video file; and
playing the audio file by using a loudspeaker if the file content includes an audio file.

16. A computer-readable medium with a computer program embodied thereon, wherein the computer program makes the computer execute following method:
obtaining a highlight application request selected on a user interface and retention time of the highlight application request;
obtaining corresponding file content according to the highlight application request if the retention time is greater than or equal to a preset threshold; and
previewing the file content.

17. The computer-readable medium according to claim 16, wherein the highlight application request is triggered and generated by a Java application.

18. The computer-readable medium according to claim 17, wherein the obtaining the corresponding file content according to the highlight application request comprises:
obtaining attribute information corresponding to the highlight application request;
obtaining a path corresponding to the file content according to the attribute information; and
extracting the file content corresponding to the highlight application request according to the path.

19. The computer-readable medium according to claim 18, wherein the obtaining the path corresponding to the file content according to the attribute information comprises:
parsing a field attribute in an application descriptor file; and
obtaining a field attribute of a preview attribute from the parsed field attribute in the application descriptor file, wherein a value of the field attribute of the preview attribute is the path corresponding to the file content.

20. The computer-readable medium according to claim 16, wherein the previewing the file content comprises at least one of following:
displaying the graphics file on a display interface in a dynamic mode if the file content includes a graphics file;
playing the video file on the display interface if the file content includes a video file; and
playing the audio file by using a loudspeaker if the file content includes an audio file.
